(19) United States
(12) Patent Application Publication
(10) Pub. No.: US 2002/0146117 A1
(43) Pub. Date: Oct. 10, 2002

(54) Public-key cryptographic schemes secure against an adaptive chosen ciphertext attack in the standard model

(76) Inventors: Mototsugu Nishioka, Yokohama (JP); Hisayoshi Satoh, Yokohama (JP); Yoichi Seto, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/046,224

(22) Filed: Jan. 16, 2002

(30) Foreign Application Priority Data
Jan. 18, 2001 (JP) 2001-009646

(51) Int. Cl. H04K 1/00

(52) U.S. Cl. 380/28; 380/30

(57) ABSTRACT

A public-key cryptographic scheme of high efficiency capable of verifying security in a standard model. In order to retain security against adaptive chosen ciphertext attacks, a ciphertext is generated by a combination of a plaintext and random numbers so that an illegal ciphertext input to a (simulated) deciphering oracle is rejected.

### FIELD OF THE INVENTION

The present invention relates to a public-key cryptographic scheme and cryptographic communications using public-key cryptography.

### DESCRIPTION OF THE RELATED ART

Various types of public-key cryptographic schemes have been proposed to date. Of these schemes, the most famous and most practical public-key cryptographic scheme is described in:

a document 1: “R. L. Rivest, A. Shamir, L. Adleman: A method for obtaining digital signatures and public-key cryptosystems, Commun. of the ACM, Vol. 21, No. 2, pp. 120-126, 1978”.

Efficient public-key cryptographic schemes using elliptic curves are known as described in:

a document 2: “V. S. Miller: Use of Elliptic Curves in Cryptography, Proc. of Crypto'85, LNCS218, Sprinter-Verlag, pp. 417-426 (1985);

a document 3: “N. Koblitz: Elliptic Curve Cryptosystems, Math. Comp., 48, 177, pp. 203-209 (1987)”; and the like.

Known cryptographic schemes capable of verifying security against chosen plaintext attacks include:

a document 4: “M. O. Rabin: Digital Signatures and Public-Key Encryptions as Intractable as Factorization, MIT, Technical Report, MIT/LCS/TR-212 (1979)”;

a document 5: “T. ElGamal: A Public Key Cryptosystem and a Signature Scheme Based on Discrete Logarithms, IEEE Trans. On Information Theory, IT-31, 4, pp. 469-472 (1985)”;

a document 6: “S. Goldwasser and S. Micali: Probabilistic Encryption, JCSS, 28, 2, pp. 270-299 (1984);

a document 7: “M. Blum and S. Goldwasser: An Efficient probabilistic public-key encryption scheme which hides all partial information, Proc. of Crypto'84, LNCS196, Springer-Verlag, pp. 289-299 (1985)”;

a document 8: S. Goldwasser and M. Bellare: Lecture Notes on Cryptography, http://www-cse.ucsd.edu/users/mihir/(1997)”; and

a document 9: “T. Okamoto and S. Uchiyama: A new Public-Key Cryptosystem as Secure as Factoring, Proc. of Eurocrypt'98, LNCS1403, Springer-Verlag, pp. 308-318 (1998)”.

Known cryptographic schemes capable of verifying security against chosen ciphertext attacks include:

a document 10: “D. Dolve, C. Dwork and M. Naor: Non-malleable cryptography, In 23rd Annual ACM Symposium on Theory of Computing, pp. 542-552 (1991)”;

a document 11: “M. Naor and M. Yung: Public-key cryptosystems probably secure against chosen ciphertext attacks, Proc. of STOC, ACM Press, pp. 427-437 (1990)”;

a document 12: “M. Bellare and P. Rogaway: Optimal Asymmetric Encryption How to Encrypt with RSA, Proc. of Eurocrypt'94, LNCS950, Springer-verlag, pp. 92-111 (1994)”; and

a document 13: “R. Cramer and V. Shoup: A practical PUblic Key Cryptosystem Probably Secure against Adaptive Chosen Ciphertext Attack, Proc. of Crypto'98, LNCS1462, Springer-Verlag, pp. 13-25 (1998)”.

A document 14: “M. Bellare, A. Desai, D. Pointcheval and P. Rogaway: Relations Among Notions of Security for Public-Key Encryption Schemes, Proc. of Crypto'98, LNSC1462, Sprinter-Verlag, pp. 26-45 (1998)”, indicates the equivalency between IND-CCA2 (semantically secure (indistinguishable) against adaptive chosen ciphertext attacks) and NM-CCA2 (non-malleable against adaptive chosen ciphertext attacks). A public-key cryptographic scheme satisfying this condition is presently considered most secure.

Although the public-key cryptographic scheme described in the document 12 is practical, security is verified on the assumption that an ideal random function exists. Since it is impossible to configure an ideal random function in a real system, the ideal random function is replaced with a practical hash function in order to apply the scheme of the document 12 to the real system. Therefore, security cannot be verified in the real system.

The document 13 provides a public-key cryptographic scheme capable of verifying IND-CCA2 on the assumption that a general one-way hash function exists instead of an ideal random function. Since the general one-way hash function can be configured really (under a cryptographic assumption), the scheme described in the document 13 can verify security in a standard model. However, when it is applied to a real system, a practical hash function such as SHA-1 is used by assuming it as a general hash function in order to improve the efficiency. Therefore, a strong assumption is incorporated in order to verify security. Although the document 13 proposes a public-key cryptographic scheme which does not assume the existence of a general one-way hash function, the efficiency of this scheme is inferior to a scheme which assumes the existence of a general one-way hash function.

### SUMMARY OF THE INVENTION

It is a main object of the present invention to provide a public-key cryptographic scheme which is practical and capable of verifying security (IND-CCA2) against strongest attacks or adaptive chosen ciphertext attacks in a standard model (a real computer model not assuming the existence of an ideal function).

It is another object of the present invention to provide a public-key cryptographic scheme which is practical and capable of verifying security even if it is applied to a real system, by assuming only the difficulty of the Diffe-Hellman decision problem.

It is another object of the invention to provide a cryptographic communication method using the public-key cryptographic scheme of the invention, a program, an apparatus and a system for executing the method.

In order to achieve the above objects of the invention, a ciphertext is created by using a combination of a plaintext and random numbers in order to reject an illegal ciphertext input to a (simulated) deciphering oracle and to guarantee security against adaptive chosen ciphertext attacks. The environment given a deciphering oracle means an environment which unconditionally gives the deciphered results of any ciphertext excepting a target ciphertext. According to one of specific public-key cryptographic schemes, the following secret-key is created:

x₁, x₂, y₁₁, y₁₂, y₂₁, y₂₂, z∈ [symbol] _{q}

and the following public key is created:

p, q: prime number (q is a prime factor of p-1)

g₁, g₂ ∈E : ordₚ(g₁)=ordₚ(g₂)=q

c=g₁^{x}^{₁}g₂^{g}^{₂} mod p, d₁=g₁^{y11}g₂^{y12} mod p, d₂=g₁^{y21}g₂^{y22} mod p, h=g₁^{z} mod p,

k₁, k₂, k₃: positive constant (10^{k}^{₁}^{+k}^{₂}<q, 10^{k}^{₃}<q, 10^{k}^{₁}^{+k}^{₂}^{+k}^{₃}<p)

(ord( ) indicates an order)

A sender generates a random number α=α₁∥α₂ (|α₁=k₁, |α₂|=k₂) for a plaintext m (|m|=k₃ where |x| indicates the number of digits of x), and calculates:

\tilde{m}α∥m

A random number r∈Zq is selected, and the following is calculated:

u₁=g₁^{r} mod p, u₂=g₂^{r} mod p, e=\tilde{m}h^{r} mod p, v=g₁^{α}^{₁}c^{r}d₁^{αr}d₂^{mr} modp

A ciphertext (u₁ u₂, e, v) is transmitted to a receiver.

By using a secret-key of the receiver and the received ciphertext, the receiver calculates α′₁, α′₂, m′(|α₁|=k₁, |α₂|=k₂), and |m′|=k₃ which satisfy:

α′₁λα′₂|m′=e/u₁^{z} mod p

If the following is satisfied;

g′₁^{α′}u₁^{x}^{₁}^{+α′y11}^{+m′y21}u₂^{x}^{₂}^{+α′y12+m′y22}≡v (mod p)

m′ is output as the deciphered results (where α′=α′₁∥α′₂), whereas if not satisfied, the effect that the received ciphertext is rejected is output as the decipher results.

### BRIEF DESCRIPTION OF THE DRAWINGS

FIG. 1 is a diagram showing the structure of a system according to an embodiment of the invention.

FIG. 2 is a diagram showing the internal structure of a sender side apparatus of the embodiment.

FIG. 3 is a diagram showing the internal structure of a receiver side apparatus of the embodiment.

FIG. 4 is a diagram showing the outline of a second embodiment of the invention.

FIG. 5 is a diagram showing the outline of a fourth embodiment of the invention.

FIG. 6 is a diaram showing the outline of a sixth embodiment of the invention.

### DETAILED DESCRIPTION OF THE EMBODIMENTS

Embodiments of the invention will be described with reference to the accompanying drawings.

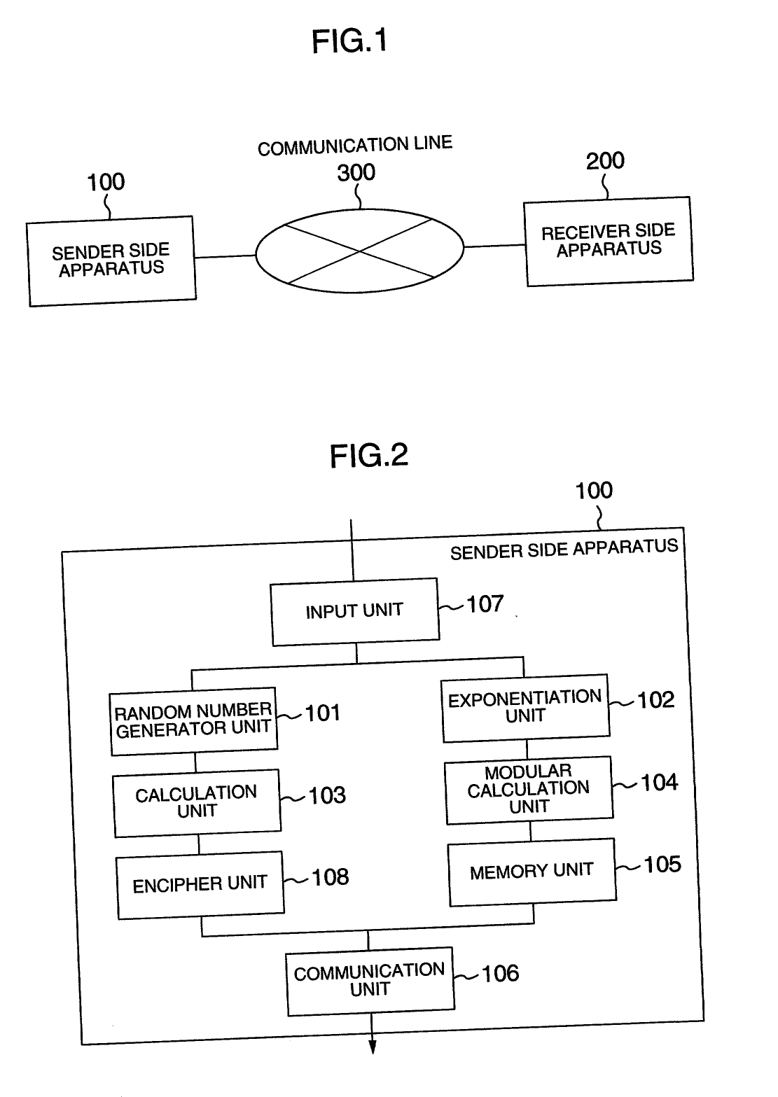

FIG. 1 is a diagram showing the structure of a system according to an embodiment of the invention. This system is constituted of a sender side apparatus 100 and a receiver side apparatus 200. The sender side apparatus 100 and receiver side apparatus 200 are connected by a communication line 300.

FIG. 2 is a diagram showing the internal structure of the sender side apparatus 100 of the embodiment. The sender side apparatus 100 has a random number generator unit 101, an exponentiation unit 102, a calculation unit 103, a modular calculation unit 104, a memory unit 105, a communication unit 106, an input unit 107 and an encipher unit 108. A plaintext m to be enciphered is input from the input unit 107, created on the sender side apparatus 100, or supplied from the communication unit 106 or an unrepresented storage unit.

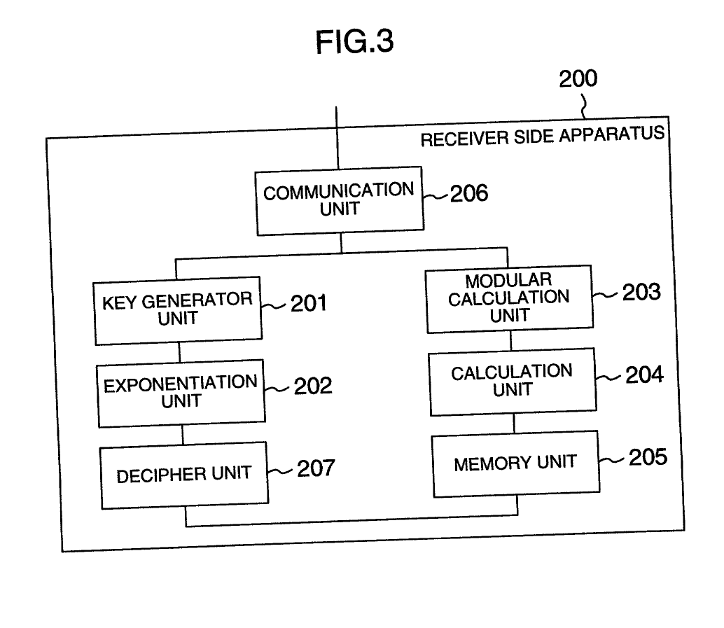

FIG. 3 is a diagram showing the internal structure of the receiver side apparatus 200 of the embodiment. The receiver side apparatus 200 has a key generator unit 201, an exponentiation unit 202, a modular calculation unit 203, a calculation unit 204, a memory unit 205, a communication unit 206 and a decipher unit 207. Although not shown, the receiver side apparatus has an output unit for supplying the user (receiver) of the apparatus with the deciphered results by means of display, sounds and the like.

The sender side apparatus 100 and receiver side apparatus 200 may be a computer having a CPU and a memory.

The random number generator unit 101, exponentiation units 102 and 202, modular calculation units 104 and 204, key generator unit 201, encipher unit 108 and decipher unit 207 each may be a custom processor matching the length of bits to be processed, or may be realized by software programs running on a central processing unit (CPU).

Processes for key generation, encipher/decipher and ciphertext transmission/reception to be described in the following embodiments are realized by software programs running on the CPU. The software programs use the above-mentioned units.

Each software program is stored in a computer readable storage medium such as a portable storage medium and a communication medium on the communication line.

I First Embodiment

This embodiment describes a public-key cryptographic scheme.

1. Key Generating Process

In response to an operation by a receiver B, the key generator unit 201 of the reception side apparatus 200 generates beforehand secret information constituted of seven numbers: 1ₓ₁, x₂, y₁₁, y₁₂, y₂₁, y₂₂, z∈ [symbol] _{q}

and public information:

G, C′: finite (multiplicative) group G⊂G′

q: prime number (the order of G)

g₁,g_{2∈}E G

c=g₁^{x}g₂^{x}^{₂}, d₁=g₁^{y11}g₂^{y}¹², d₂=g₁^{y21}g₂^{y22}, h=9g₁^{z},

π: X₁×X₂×M→G¹: one-to-one mapping

π⁻¹: Im(π)→X₁×X₂×M

where the group G is a partial group of the group G′, X₁ and X₂ are an infinite set of positive integers which satisfy:

α₁∥α₂<q(∀α₁∈X₁, ∀α₂∈X₂)

M is a plaintext space, and ∥ represents a concatenation of bit trains. The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

(1) In response to an operation by a sender A, the random number generator unit 101 of the sender side apparatus 100 selects random numbers α₁∈X₁, α₂∈X₂, r∈Zq for the plaintext m (m∈M), and the exponentiation unit 102, calculation unit 103 and modular calculation unit 104 calculate:

u₁=g₁^{r}, u₂=g₂^{r}, e=π(α₁,α₂,m)h^{r}, v=g₁^{α}^{₁}c^{r}d₁^{αr}d₂^{mr}

where α=α₁∥α₂. In response to an operation by the sender A, the communication apparatus 106 of the sender side apparatus 100 transmits the ciphertext (u₁, u₂, e, v) to the receiver side apparatus 200 via the communication line 300.

(2) In response to an operation by the receiver B, the exponentiation unit 202, modular calculation unit 203 and calculation unit 204 of the receiver side apparatus 200 calculate, from the received ciphertext and by using the secret information, all α′₂, α′₂, m′ (α′₁∈X₁, α′₂∈X₂, m′∈M) which satisfy:

π(α′₁, α′₂, m′)=e/u₁^{z}

If the following is satisfied:

$${{g}_{1}}^{{α}_{1}^{′}} {{u}_{1}}^{{x}_{1} + {α}^{′} {y}_{11} + {m}^{′} {y}_{21}} {{u}_{2}}^{{x}_{2} + {α}^{′} {y}_{12} + {m}^{′} {y}_{22}} = υ$$

m′ is output as the deciphered results (where α′=α′₁∥α′₂), whereas if not satisfied, the effect that the received ciphertext is rejected is output as the decipher results.

With the scheme of this embodiment, it is possible to be semantically secure against adaptive chosen ciphertext attacks on the assumption of the Diffie-Hellman decision problem in G. The Diffie-Hellman decision problem is a problem of deciding whether a given sequence δ belongs to which one of the sets:

D={(g₁,g₂,g₁^{r}, g₂^{r})|r∈ [symbol] _{q}}, R={(g₁,g₂,g₁^{r}^{₁}, g₂^{r}^{₂})|r₁, r₂∈ [symbol] q, r₁≠r₂}

relative to g₁, g₂∈G:

If it is difficult to solve the Diffie-Hellman decision problem at a probability better than ½, it is said that the Diffie-Hellman decision problem is difficult (for the Diffie-Hellman decision problem, refer to the document 13 and the like).

The procedure of verifying security shows that if an algorithm capable of attacking the embodiment method exists, by using this algorithm (specifically, by the method similar to the method described in the document 12), an algorithm for solving the Diffie-Hellman decision problem can be configured.

Even if the algorithm for solving the Diffie-Hellman decision problem exists, since an algorithm capable of attacking the embodiment method is not still found, attacking the embodiment method is more difficult than solving at least the Diffie-Hellman decision problem.

With the embodiment method, when a ciphertext is generated in response to an operation by the sender A, the sender side apparatus 100 selects beforehand the random numbers α₁∈X₁, α₂∈X₂ and r∈Zq and calculates and stores beforehand:

u₁=g₁^{r}, u₂=g₂^{r}, h^{r}, g₁^{α}^{₁}c^{r}d₁^{αr}

Therefore, a load of an encipher process can be reduced considerably and the process time can be shortened.

II Second Embodiment

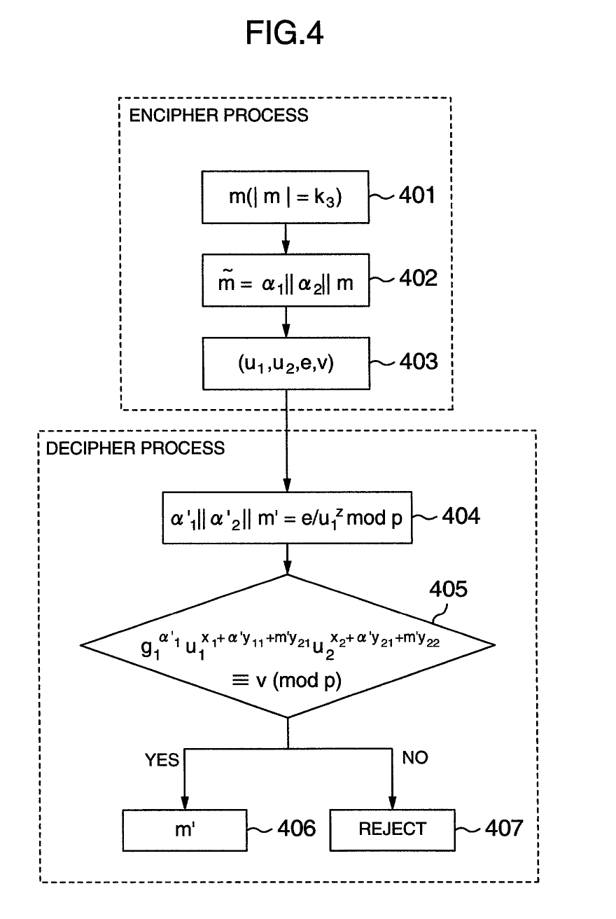

The second embodiment shows one of the methods of realizing the public-key cryptographic scheme of the fist embodiment, and adopts concatenation of three parameters as a function π. FIG. 4 shows the outline of this embodiment.

1. Key Generation Process

In response to an operation by the receiver B, the key generator unit 201 of the reception side apparatus 200 generates beforehand secret information:

x₁,x₂,y₁₁, y₁₂, y₂₁,y₂₂, z∈Z_{q}

and public information:

p, q: prime number (q is a prime factor of p-1)

g₁,g₂∈Zₚ: ordₚ(g₁)=ordₚ(g₂)=q

c=g₁^{x}^{₁}g₂^{x2} mod p, d₁=g₁^{y11}g₂^{y12} mod p, d₂^{y12}g₂^{y22} mod p, h=g₁^{z} mod p,

k₁, k₂, k₃: positive constant (10^{k}^{₁}^{+k}₂<q, 10^{k}^{₃}<q, 10^{k}^{₁}^{+k}^{₂}^{+k}^{₃}<p)

(ord ( ) indicates an order)

The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

(1) In response to an operation by the sender A, the random number generator unit 101 of the sender side apparatus 100 selects random numbers α=α₁∥α₂(|α₁|=k₁, |α₂|=k₂) for a plaintext m (|m|=k₃, where |x| indicates the number of digits of x) (step 401), and calculates (Step 402):

\tilde{m}=α∥m

The random number generator unit 101 further selects a random number r∈Zq, and the exponentiation unit 102, calculation unit 103 and modular calculation unit 104 calculates:

u₁=g₁^{r}mod p, u₂=g₂^{r}mod p, e=\tilde{m}h^{r}mod p, v=g₁^{α}^{₁}c^{r}d₁^{αr}d₂^{mr} mod p

In response to an operation by the sender A, the communication apparatus 106 of the sender side apparatus 100 transmits (u₁, u₂, e, v) as the ciphertext to the receiver side apparatus 200 of the receiver B via the communication line 300 (Step 403).

(2) In response to an operation by the receiver B, the exponentiation unit 202, modular calculation unit 203 and calculation unit 204 of the receiver side apparatus 200 calculate (Step 404), from the received ciphertext and by using the secret information, α′₁, α′₂, m′ (|α′₁|=k₁, |α′₂|=k₂, |m′=k₃) which satisfy:

α′₁∥α′₂∥m′=e/u₁^{z} mod p

If the following is satisfied (Step 405):

$${{g}_{1}}^{{α}_{1}^{′}} {{u}_{1}}^{{x}_{1} + {α}^{′} {y}_{11} + {m}^{′} {y}_{21}} {{u}_{2}}^{{x}_{2} + {α}^{′} {y}_{12} + {m}^{′} {y}_{22}} ≡ υ ( mod p )$$

m′ is output as the deciphered results (where α′=α′₁∥α′₂) (Step 406), whereas if not satisfied, the effect that the received ciphertext is rejected is output as the decipher results (Step 407).

With the embodiment method, when a ciphertext is generated in response to an operation by the sender A, the sender side apparatus 100 selects beforehand the random numbers α₁, α₂ (|α₁|=k₁, |·₂|=k₂) and r∈Zq and calculates and stores beforehand:

u₁=g₁^{r} mod p, u₂=g₂^{r} mod p, h^{r} mod p, g₁^{α}^{₁}c^{r}d₁^{αr}mod p

Therefore, a load of an encipher process can be reduced considerably.

III Third Embodiment

In this embodiment, the message sender A enciphers transmission data m to the receiver B by common-key encipher (symmetric cryptography), and the common key used is enciphered by the public-key cryptographic scheme of the first embodiment to be sent to the receiver B.

1. Key Generating Process

In response to an operation by the receiver B, the key generator unit 201 of the reception side apparatus 200 generates beforehand secret information:

x₁, x₂, y₁₁, y₁₂, y₂₁, y₂₂, z∈Z_{q}

and public information:

G, C′: finite (multiplicative) group G⊂G′

q: prime number (the order of G)

g₁, g₂∈C

c=g₁^{x}^{₁}g₂^{x}^{₂}, d₁=g₁^{y11}g₂^{y12}, d₂=g₁^{y21}, g₂^{y22}, h=g₁^{z},

π: X₁×X₂×M , G′: one-to-one mapping

π⁻¹: Im(π)→X₁×X₂×M

E: symmetric encipher function

where the group G is a partial group of the group G′, X₁ and X₂ are an infinite set of positive integers which satisfy:

α₁∥α₂<q (∀α₁∈X₁, ∀α₂∈X₂)

M is a key space. The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

(1) In response to an operation by the sender A, the random number generator unit 101 of the sender side apparatus 100 selects random numbers α₁∈X₁, α₂∈X₂, r∈Zq for the plaintext m (m∈M), and the exponentiation unit 102, calculation unit 103 and modular calculation unit 104 calculate:

u₁=g₁^{r}, u₂=g₂^{r}, e=π(α₁,α₂,K)h^{r}, v=g₁^{α1}c^{r}d₁^{αr}d₂^{Kr}

where α=α₁∥α₂. A ciphertext C of the transmission data m is generated by:

C=E_{K}(m)

by using the symmetric cryptographic function E and key data K. In response to an operation by the sender A, the communication apparatus 106 of the sender side apparatus 100 transmits (u₁, u₂, e, v, C) as the ciphertext to the receiver side apparatus 200 via the communication line 300.

(2) In response to an operation by the receiver B, the exponentiation unit 202, modular calculation unit 203 and calculation unit 204 of the receiver side apparatus 200 calculate, from the received ciphertext and by using the secret information, α′₁, α′₂, K′ (α′₁∈X₁, α′₂∈X₂, K′∈M) which satisfy:

π(α′₁∥α′₂∥K′)=e/u₁^{z}

If the following is satisfied (where α′=α′₁∥α′₂)

$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} = υ$$

a decipher process is executed by:

m=D_{K′}(C)

where D is a decipher function corresponding to E. The deciphered results are output. If not satisfied, the effect that the received ciphertext is rejected is output as the decipher results.

As another method of generating a ciphertext C, the sender generates the ciphertext C by:

C=E_{K}(α₁∥α₂∥m)

by using the (symmetric) cryptographic function E and key data K. The receiver checks whether the following is satisfied:

$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} = υ , {α}_{1}^{′} ‖ {α}_{2}^{′} = {[ {D}_{{K}^{′}} ( C ) ]}^{{k}_{1} + {k}_{2}}$$

where [x]^{k} indicates the upper k digits. If the check passes, a decipher process is executed by:

m=[D_{K′}(C)]^{-(k}^{₁}^{+k}^{₂})

where [x]^{-k} indicates an integer train of x removed with the upper k digits.

With the embodiment method, when a ciphertext is generated in response to an operation by the sender A, the sender side apparatus 100 selects beforehand the random numbers (α₁∈X₁, α₂∈X₂ and r∈Zq and calculates and stores beforehand:

u₁=g₁^{r}, u₂=g₂^{r}, h^{r}, g₁α₁c^{r}d₁^{αr}

Therefore, a load of an encipher process can be reduced considerably and the process time can be shortened.

IV Forth Embodiment

In this embodiment, the message sender A enciphers transmission data m to the receiver B by common-key encipher (symmetric cryptography), and the common key used is enciphered by the public-key cryptographic scheme of the second embodiment to be sent to the receiver B.

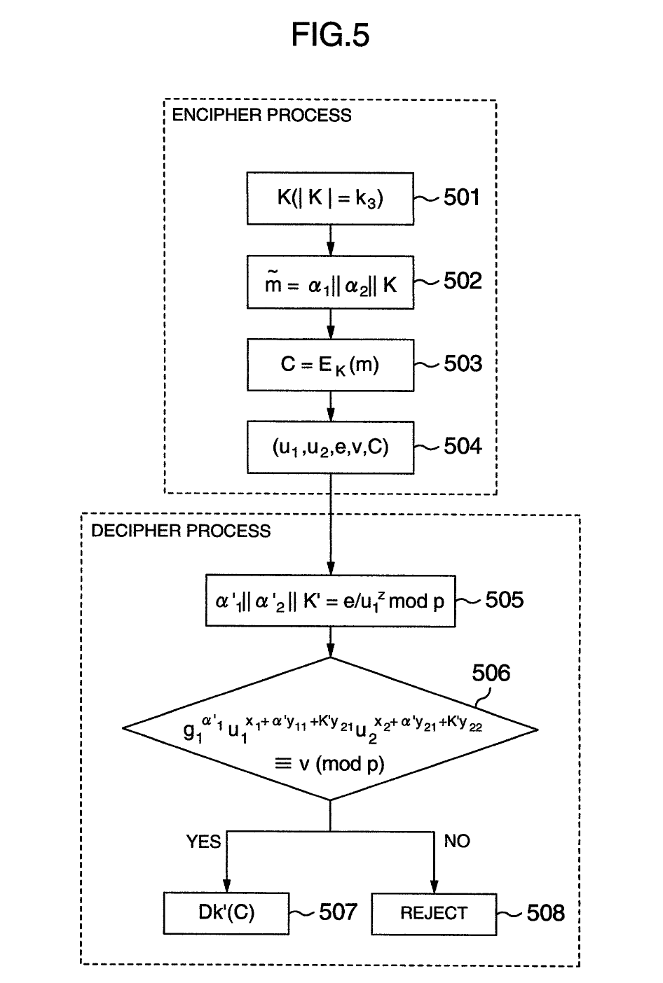

FIG. 5 shows the outline of the embodiment.

1. Key Generating Process

In response to an operation by the receiver B, the key generator unit 201 of the reception side apparatus 200 generates beforehand secret information:

x₁, x₂, y₁₁, y₁₂, y₂₁, y₂₂, Z∈ [symbol] _{q}

and public information:

p, q: prime number (q is a prime factor of p-1)

g₁,g₂∈ [symbol] ₚ: ordₚ(g₁)=ordₚ(g₂)=q

c=g₁^{z}^{₁}g₂^{x}^{₂} mod p, d₁=g₁^{y11}g₂^{y12} mod p, d₂=g₁^{y21}g₂^{y22} mod p, h=g₁^{z} mod p,

k₁, k₂, k₃: positive constant (10^{k}^{₁}^{+k}^{₂}<q, 10^{k}^{₃}<q, 10^{k}^{₁}^{+k}₂+k₃<p)

E: symmetric encipher function

The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

(1) In response to an operation by the sender A, the random number generator unit 101 of the sender side apparatus 100 selects random numbers α=α₁∥α₂(|α₁|=k₁, |α₂|=k₂) for the key data K (Step 501) (|K|=k₃ where |x| indicates the number of digits of x), and calculates (Step 502):

\tilde{m}=α∥K

The random number generator unit 101 selects a random number r∈Zq, and the exponentiation unit 102, calculation unit 103 and modular calculation unit 104 calculate:

u₁=g₁^{r}mod p, u₂=g₂^{r} mod p, e=\tilde{m}h^{r}mod p, v=g₁^{α}^{₁}c^{r}d₁^{αr}d₂^{mr} mod p

In response to an operation by the sender A, the sender side apparatus 100 generates a ciphertext C of the transmission data m by:

C=E_{K}(m)

by using the (symmetric) cryptographic function E and key data K (Step 503), and the communication unit 106 transmits (u₁, u₂, e, v, C) as the ciphertext to the receiver side apparatus 200 via the communication line 300 (Step 504).

(2) In response to an operation by the receiver B, the exponentiation unit 202, modular calculation unit 203 and calculation unit 204 of the receiver side apparatus 200 calculate (Step 505), from the received ciphertext and by using the secret information, α′₁, α′₂, K′ (|α′₁|=k₁, |α′₂|=k₂, |K′|=k₃) which satisfy:

α′₁∥α′₂∥K′=e/u₁^{z}mod p

If the following is satisfied (where α′=α′₁∥α′₂) (Step 506):

$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} ≡ υ ( mod p )$$

a decipher process is executed (Step 507) by:

m=D_{K′}(C)

where D is a decipher function corresponding to E. The deciphered results are output. If not satisfied, the effect that the received ciphertext is rejected is output as the decipher results (Step 508).

As another method of generating a ciphertext C, the sender generates the ciphertext C by:

C=E_{K}(α₁∥α₂∥K)

by using the (symmetric) cryptographic function E and key data K. The receiver checks whether the following is satisfied:

$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} ≡ υ ( mod p ) , \\ {α}_{1}^{′} ‖ {α}_{2}^{′} = {[ {D}_{{K}^{′}} ( C ) ]}^{{k}_{1} + {k}_{2}}$$

If the check passes, a decipher process is executed by:

m=[D_{K′}(C)]^{-(k}^{₁}^{+k}^{₂})

where [x]^{-k} indicates an integer train of x removed with the upper k digits.

With the embodiment method, when a ciphertext is generated in response to an operation by the sender A, the sender side apparatus 100 selects beforehand the random numbers α₁, α₂, (|α₁|=k₁, |α₂|=k₂), r∈Zq and calculates and stores beforehand:

u₁=g₁^{r}mod p, u₂=g₂^{r}mod p, h^{r}mod p, g₁^{α}^{₁}c^{r}d₁^{αr}mod p

Therefore, a load of an encipher process can be reduced considerably.

V Fifth Embodiment

In this embodiment, the message sender A transmits transmission data m to the receiver B by cryptographic communications by using symmetric cryptography based upon the public-key cryptography of the first embodiment. This embodiment is more excellent in the efficiency than the method of the third embodiment. If the symmetric cryptography is non-malleable (IND-CPA) against chosen plaintext attacks, it is possible to verify that the symmetric cryptography is non-malleable against adaptive chosen ciphertext attacks (NM-CCA2). In the embodiment method, a key K itself is not transmitted but the sender and receiver share a seed so that the key can be generated.

1. Key Generating Process

In response to an operation by the receiver B, the key generator unit 201 of the reception side apparatus 200 generates beforehand secret information:

x₁, x₂, y₁, y₂, z∈Z_{q}

and public information:

G, C : finite (multiplicative) group G⊂C′

q: prime number (the order of G)

g₁,g₂⊂G

c=g₁^{x}^{₁}g₂^{x}^{₂}, d=g₁^{y1}g₂^{y2}, h=g₁^{z},

π: X₁×X₂×M→Dom(E): one-to-one mapping (Dom(E) is the domain of the function E)

π⁻¹: Im(π)→X₁×X₂×M

H: hash function

E: symmetric encipher function

where the group G is a partial group of the group GI, X₁ and X₂ are an infinite set of positive integers which satisfy:

α₁μα₂<q(∀α₁∈X₁, ∀α₂∈X₂)

The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

(1) In response to an operation by the sender A, the random number generator unit 101 of the sender side apparatus 100 selects random numbers α₁∈X₁, α₂∈X₂, r∈Zq for transmission data m (m∈M, M is a plaintext space), and the exponentiation unit 102, calculation unit 103 and modular calculation unit 104 calculate:

u₁=g ₁^{r}, u₂=g₂^{r}, v=g₁^{α}^{₁}c^{r}d^{αr}, K=H(h^{r})

where α=α₁∥α₂. A ciphertext C of the transmission data m is generated by:

C=E_{K}(π((α₁, α₂, m))

by using the (symmetric) cryptography. In response to an operation by the sender A, the communication apparatus 106 of the sender side apparatus 100 transmits (upl u₂, V, C) as the ciphertext to the receiver side apparatus 200 via the communication line 300.

(2) In response to an operation by the receiver B, the exponentiation unit 202, modular calculation unit 203 and calculation unit 204 of the receiver side apparatus 200 calculate:

K′=H(u₁^{z})

by using the secret information, and further calculate, from the received ciphertext, α′₁, α′₂, α₁∈=X₁, α′₂ E X₂) which satisfy:

π(α′₁, α′₂, m′)=D_{K′}(C)

where D is a cryptographic function corresponding to E. If the following is satisfied:

$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} = υ ,$$

m′ is output as the deciphered results (where α′=α′₁λα′₂), whereas if not satisfied, the effect that the received ciphertext is rejected is output as the decipher results.

With the embodiment method, when a ciphertext is generated in response to an operation by the sender A, the sender side apparatus 100 selects beforehand the random numbers α₁∈X₁, α₂∈X₂ and r∈Zq and calculates and stores beforehand u₁, u₂ and v. Therefore, a load of an encipher process can be reduced considerably and the process time can be shortened.

VI Sixth Embodiment

In this embodiment, the message sender A transmits transmission data m to the receiver B by cryptographic communications by using symmetric cryptography based upon the public-key cryptography of the second embodiment.

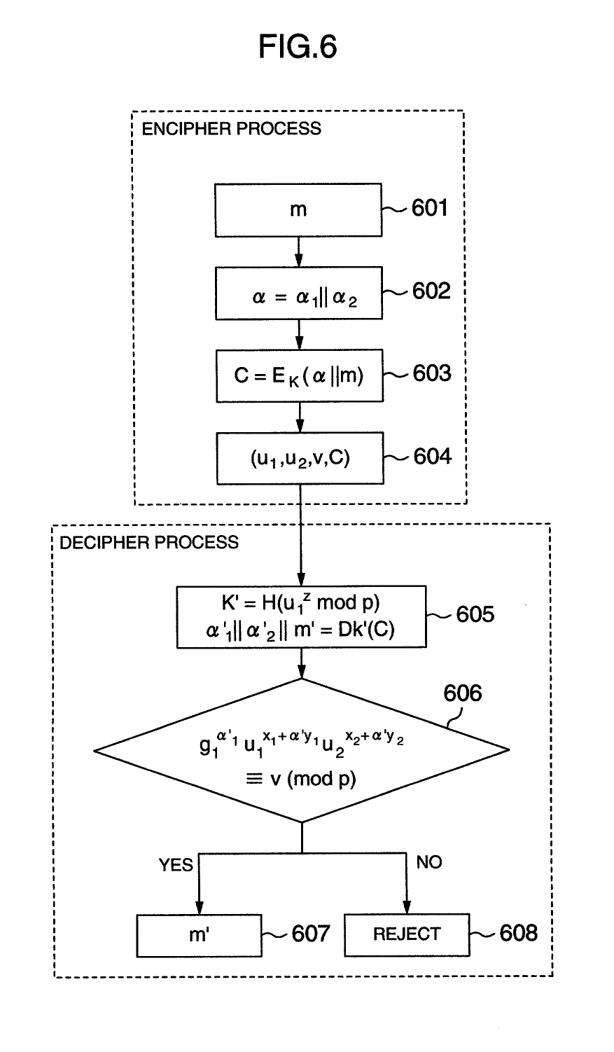

FIG. 6 illustrates the outline of the embodiment.

1. Key Generating Process

In response to an operation by the receiver B, the key generator unit 201 of the reception side apparatus 200 generates beforehand secret information:

x₁, x₂, y₁, y₂, z∈Z_{q}.

and public information:

p, q : prime number (q is a prime factor of p-1)

g₁, g₂∈Zₚ: ordₚ(g₁)=ordₚ(g₂)=q

c=g₁^{x}^{₁}g₂^{x}^{₂} mod p, d=g₁^{y1}g₂^{y2} mod p, h=g₁^{z} mod p,

k₁, k₂, k₃: positive constant (10^{k}^{₁}^{+k}^{₂}<q, 10^{k}^{₃}<q, 10^{k}^{₁}^{+k}^{₂}^{+k}^{₃}<p)

H: hash function

E: symmetric encipher function (the domain of E is all positive integers)

The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

In response to an operation by the sender A, the random number generator unit 101 of the sender side apparatus 100 selects (step 602) random numbers α=α₁∥α₂(|α₁|=k₁, α₂|=k₂, where |x| is the number of digits of x) for the plaintext m (m∈M, M is a plaintext space) (Step 601), and further selects a random number r∈Zq. The exponentiation unit 102, calculation unit 103 and modular calculation unit 104 calculate:

u₁=g₁^{r}mod p, u₂=g₂^{r}mod p, v=g₁^{α}^{₁}c^{r}d^{αr}mod p, K=H(h^{r} mod p)

The sender side apparatus 100 generates a ciphertext C of the transmission data m by:

C=E_{K}(α₁∥α₂∥m)

by using the (symmetric) cryptographic function E (Step 603). The communication apparatus 106 transmits (ul, U₂, V, C) as the ciphertext to the receiver side apparatus 200 via the communication line 300 (Step 604).

In response to an operation by the receiver B, the exponentiation unit 202, modular calculation unit 203 and calculation unit 204 of the receiver side apparatus 200 calculate:

K′=H(u₁^{z}mod p)

by using the secret information, and further calculate (Step 605), from the received ciphertext, (α′₁, α′₂, (|α′₁, α′₂(|α′₁|=k₁, |α′₂|=k₂) which satisfy:

a′1II2IIm′ =DKI(C)

If the following is satisfied (Step 606):

$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} ≡ υ ( mod p )$$

m′ is output as the deciphered results (where α′=α′₁∥α′₂) (Step 607), whereas if not satisfied, the effect that the received ciphertext is rejected is output as the decipher results (Step 608).

With the embodiment method, when a ciphertext is generated in response to an operation by the sender A, the sender side apparatus 100 selects beforehand the random numbers α₁, α₂ (|α₁|=k₁, |α₂|=k₂) and r Zq, and calculates and stores beforehand u₁, u₂ and v. Therefore, a load of an encipher process can be reduced considerably and the process time can be shortened.

VII Seventh Embodiment

In this embodiment, the message sender A transmits transmission data m to the receiver B by cryptographic communications by using another asymmetric cryptography and the public-key cryptography of the first embodiment. In this embodiment, a weak asymmetric cryptography (NM-CPA) can be transformed into a non-malleable cryptography (NM-CCA2).

1. Key Generating Process

In response to an operation by the receiver B, the key generator unit 201 of the reception side apparatus 200 generates beforehand secret information:

x₁, x₂, y₁, y₂∈ [symbol] _{q}

sk : (asymmetric) decipher key

and public information:

G: finite (multiplicative) group

q: prime number (the order of G)

g₁,g₂∈G

c=g₁^{x}^{₁}g₂^{x}^{₂}, d=g₁^{y1}g₂^{y2},

π: X₁×X₂×M→Dom(E): one-to-one mapping (Dom(E) is the domain of the function E)

π⁻¹: Im(π)→X₁×X₂×M

Eₚₖ(·): (asymmetric cryptography) encipher function

where the group G is a partial group of the group G′, X₁ and X₂ are an infinite set of positive integers which satisfy:

α₁∥α₂<q(∀α₁∈X₁, ∀α₂∈X₂)

M is a plaintext space. The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

In response to an operation by the sender A, the random number generator unit 101 of the sender side apparatus 100 selects random numbers α₁∈X₁, α₂∈X₂, r∈Zq, and the exponentiation unit 102, calculation unit 103 and modular calculation unit 104 calculate:

u₁=g₁^{r}, u₂=g²^{r}, v=g^{α1}c^{r}d^{αr}

where α=α₁∥α₂. The sender side apparatus 100 generates a ciphertext C of the transmission data m by:

e=Eₚₖ(π(α₁,α₂,m))

by using the (asymmetric) cryptographic function Eₚₖ. In response to an operation by the sender A, the communication apparatus 106 transmits (u₁, u₂, e, v) as the ciphertext to the receiver side apparatus 200 via the communication line 300.

In response to an operation by the receiver B, the exponentiation unit 202, modular calculation unit 203 and calculation unit 204 of the receiver side apparatus 200 calculate, from the received ciphertext, α′₁, α′₂ and m′ (α′₁∈X₁, α′₂′∈X₂, α′∈X₂, and m′∈M) which satisfy:

π(α′₁,α′₂,m′)=Dₛₖ(e)

(where Dₛₖ is a decipher function corresponding to Eₚₖ) by using the secret information. If the following is satisfied:

$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} = υ$$

where:

m′ is output as the deciphered results, whereas if not satisfied, the effect that the received ciphertext is rejected is output as the decipher results. With the embodiment method, when a ciphertext is generated in response to an operation by the sender A, the sender side apparatus 100 selects beforehand the random numbers α′₁∈X₁, α′₂∈X₂, and r∈Zq and calculates and stores beforehand u₁, u₂ and v. Therefore, a load of an encipher process can be reduced considerably and the process time can be shortened.

VIII Eighth Embodiment

In this embodiment, similar to the seventh embodiment, the message sender A transmits transmission data m to the receiver B by cryptographic communications by using the asymmetric cryptography based upon the public-key cryptography of the second embodiment.

1. Key Generating Process

In response to an operation by the receiver B, the key generator unit 201 of the reception side apparatus 200 generates beforehand secret information:

x₁,x₂, y₁, y₂∈ [symbol] _{q}

sk: (asymmetric cryptography) decipher key

and public information:

p, q: prime number (q is a prime factor of p-1)

g ₁, g₂∈ [symbol] ₚ: ordₚ(g₁)=ordₚ(g₂)=q

c=g₁^{x}^{₁}g₂^{x}^{₂} mod p, d=g₁^{y1}g₂^{y2} mod p,

k₁, k₂: positive constant (10^{k}^{₁}^{+k}^{₂}<q)

Eₚₖ(′): (asymmetric cryptography) encipher function (the domain is all positive integers)

The public information is supplied to the sender side apparatus 100 or made public, via the communication line 300 or the like. A publicizing method may be registration in the third party (public information management facilities) or may be a well-known method. Other information is stored in the memory unit 205.

2. Encipher/Decipher Process

In response to an operation by the sender A, the random number generator unit 101 of the sender side apparatus 100 selects random numbers α=α₁∥α₂(|α₀|=k₁, |α₂|=k₂, where |x| is the number of digits of x), and further selects a random number r∈Zq. The exponentiation unit 102, calculation unit 103 and modular calculation unit 104 calculate:

u₁=g₁^{r} mod p, u₂=g₂^{r} mod p, v=g₁^{α}^{₁}c^{r}d^{αr}mod p

In response to an operation by the sender A, the sender side apparatus 100 generates a ciphertext C of the transmission data m (positive integer) by:

e=Eₚₖ(α₁∥α₂∥m)

by using the (asymmetric) cryptographic function E. The communication apparatus 106 transmits (u₁, u₂, e, v) as the ciphertext to the receiver side apparatus 200 via the communication line 300.

In response to an operation by the receiver B, the exponentiation unit 202, modular calculation unit 203 and calculation unit 204 of the receiver side apparatus 200 calculate, from the received ciphertext and by using the secret information, α′₁, α′₂ and m′ (|α′₁=k₁, |α′₂|=k₂, m′ is a positive integer) which satisfy:

α′₁∥α′₂∥m′=Dₐₖ(e)

where Dₛₖ is a decipher function corresponding to Eₚₖ.

If the following is satisfied:

$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} ≡ υ ( mod p ) ,$$

where:

αa′α′₁μα′₂

m′ is output as the deciphered results, whereas if not satisfied, the effect that the received ciphertext is rejected is output as the decipher results. With the embodiment method, when a ciphertext is generated in response to an operation by the sender A, the sender side apparatus 100 selects beforehand the random numbers α′₁∈X₁, α′₂(|α₁|=k₁, |α₂|=k₂, and r∈Zq and calculates and stores beforehand u₁, u₂ and v. Therefore, a load of an encipher process can be reduced considerably.

In each of the embodiments described above, cryptographic communications are performed by using the apparatuses of the sender and receiver, which is a general system. Various systems may also be used.

For example, in an electronic shopping system, a sender is a user, a sender side apparatus is a computer such as a personal computer, a receiver is a retail shop and its clerk, and a receiver side apparatus is an apparatus in the retail shop such as a computer, e.g., a personal computer in the shop. An order sheet of a commodity ordered by the user or a key generated when the order sheet is enciphered is enciphered by the embodiment method and transmitted to the apparatus of the retail shop.

In an email cryptographic system, each apparatus is a computer such as a personal computer, and a message of the sender or a key generated when the message is enciphered is enciphered by the embodiment method and transmitted of the receiver side computer.

Each embodiment is also applicable to various systems using conventional cryptographic techniques.

Various digitalized data (multimedia data) can be used as a plaintext or message of each embodiment. Calculations of each embodiment are performed by executing each program in a memory by a CPU. Some of calculations may be performed not by a program but by a hardware calculation unit which transfers data to and from another calculation unit and CPU.

What is claimed is:

1. A public-key cryptographic scheme comprising:
a key generation step of generating a secret-key:
X₁, x₂,y₁₁, y₁₂, y₂₁, y₂₂,z∈ [symbol] _{q}
and a public-key:
a G, G′: finite (multiplicative) group G⊂C′
q: prime number (the order of G)
g₁,g₂∈C
c=g₁^{x}^{₁}g^{x}^{₂}, d₁=g₁^{y11}g₂^{y12}, d₂=g₁_{y21}, g₂^{y22}, h=g₁^{z},
π: X₁×X₂×M→G′: one-to-one mapping
π⁻¹:Im(90 )→X₁×X₂×M
where the group G is a partial group of the group G′, X₁ and X₂ are an infinite set of positive integers which satisfy:
α₁∥α₂<q(∀α₁∈X₁, ∀α₂ÅX₂)
where M is a plaintext space;
a ciphertext generation and transmission step of selecting random numbers α₁∈=X₁, α₂∈X₂, r∈Zq for a plaintext m (m∈M), calculating:
u₁=g₁^{r}, u₂=g₂^{r}, e=π(α₁, α₂, m)h^{r}, v=g₁^{α}^{₁}c^{r}d₁^{αr}d₂^{mr}
where α=α₁∥α₂, and transmitting (u₁, u₂, e, v) as a ciphertext; and
a ciphertext reception and decipher step of calculating from the received ciphertext and by using the secret key, α′₁, α′₂, m′ ((α′₁531 X₁, α′₂∈X₂, m′∈M) which satisfy:
π(α′₁, α′₂,m′)=e/u₁^{z}
and if the following is satisfied:
$${{g}_{1}}^{{α}_{1}^{′}} {{u}_{1}}^{{x}_{1} + {α}^{′} {y}_{11} + {m}^{′} {y}_{21}} {{u}_{2}}^{{x}_{2} + {α}^{′} {y}_{12} + {m}^{′} {y}_{22}} = υ$$
outputting m′ as the deciphered results (where α′=α′₁∥α′₂), whereas if not satisfied, outputting as the decipher results the effect that the received ciphertext is rejected.

2. A public-key cryptographic scheme comprising:
a key generation step of generating a secret-key:
x₁, x₂, y₁₁, y₁₂, y₂₁, y₂₂, z∈ [symbol] _{q}
and a public-key:
p q : prime number (q is a prime factor of p-1)
g₁,g₂∈ [symbol] ₚ: ordₚ(g₁)=ordₚ(g₂)=q
c=g₁^{x}^{₁}g₂^{x}^{₂} mod p, d₁=g₁^{y11}g₂^{y12} mod p, d₂=g₁^{y21}g₂^{y22} mod p, h=g₁^{z} mod p,
k₁, k₂, k₃: positive constant (10 ^{k}^{₁}^{+k}^{₂}<q, 10^{k}^{₃}<q, 10^{k}^{₁}^{+k}^{₂}^{+k}^{₃}<p)
a ciphertext generation and transmission step of selecting random numbers α=α₁∥α₂ (|α₁|=k₁, |α₂|=k₂) for a plaintext m (|m|=k₃ where |x| is the number of digits of x), calculating:
\tilde{m}=α∥K
selecting a random number r∈Zq, calculating:
u₁g₁^{r}mod p, u₂=g₂^{r} mod p, e=\tilde{m}h^{r}mod p, v=g₁^{α}^{₁}c^{r}d₁αrd₂^{mr}mod p
and transmitting (u₁, u₂, e, v) as a ciphertext; and
a ciphertext reception and decipher step of calculating from the received ciphertext and by using the secret key, α′₁, α′₂, m′ (|α′₁|=k₁, |α′₂|=k₂, |m′|=k₃) which satisfy:
α′₁∥α′₂λm′=e/u₁^{z}mod p
and if the following is satisfied:
$${{g}_{1}}^{{α}_{1}^{′}} {{u}_{1}}^{{x}_{1} + {α}^{′} {y}_{11} + {m}^{′} {y}_{21}} {{u}_{2}}^{{x}_{2} + {α}^{′} {y}_{12} + {m}^{′} {y}_{22}} ≡ υ ( mod p )$$
outputting m′ as the deciphered results (where α′=α′₁∥α′₂), whereas if not satisfied, outputting as the decipher results the effect that the received ciphertext is rejected.

3. A public-key cryptographic scheme according to claim 1, wherein the public-key is generated by a receiver and is made public.

4. A public-key cryptographic scheme according to claim 1, wherein in said ciphertext transmission step, the random numbers α₁∈X₁, α₂∈X₂ and r∈Zq are selected beforehand and the following is calculated and stored beforehand:
u₁=g₁^{r}, u₂=g₂^{r}, h^{r}, g₁^{α}^{₁}c^{r}d₁^{αr}

5. A public-key cryptographic scheme according to claim 2, wherein in said ciphertext transmission step, the random numbers α₁, α₂ (|α₁|=k₁, α_{2|}=k₂) and r∈Zq are selected beforehand and the following is calculated and stored beforehand:
u₁=g₁^{r}mod p, u₂=g₂^{r}mod p, h^{r} mod p, g₁^{α}^{₁}c^{r}d₁^{αr}mod p

6. A cryptographic communication method comprising:
a key generation step of generating a secret-key: and a public-key:
G, G′: finite (multiplicative) group G⊃C′
q: prime number (the order of G)
g₁,g₂∈G
c=g₁^{x}^{₁}g₂^{x}^{₂}, d₁=g₁^{y11}g₂^{y12}, d₂ g₁^{y21}g^{Y22}h=g₁^{z},
π: X₁×X₂×M→C′: one-to-one mapping
π⁻¹: Im(π)X₁×X_{2×}M
E: symmetric encipher function
where the group G is a partial group of the group G′, X₁ and X₂ are an infinite set of positive integers which satisfy:
α₁∥α₂<q(∀α₁∈X₁, ∀α₂∈X₂)
where M is a key space;
a ciphertext generation and transmission step of selecting random numbers α₁∈X₁, α₂∈X₂, r∈Zq for key data K (K E M), calculating:
u₁=g₁^{r}, u₂=g₂^{r}, e=π(α₁,α₂,K)h^{r}, v=g₁^{α}^{₁}c^{r}d₁^{αr}d₂^{Kr}
where α=α₁∥α₁, generating a ciphertext C of transmission data m by:
C=E_{K}(m)
by using a (symmetric cryptographic function E and key data K, and transmitting (u₁, u₂, e, v, C) as the ciphertext; and
a ciphertext reception and decipher step of calculating from the received ciphertext and by using the secret key, α′₁, α′2, K′ (α′₁∈X₁, α₂∈X₂, K′∈M) which satisfy:
π(α′₁∥α′₂∥K′)=e/u₁^{z}
and if the following is satisfied:
$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} = υ$$
where α′=α′₁∥α′₂
executing a decipher process by:
m=D_{K′}(C)
outputting deciphered results, whereas if not satisfied, outputting as the decipher results the effect that the received ciphertext is rejected.

7. A cryptographic communication method according to claim 6, wherein the ciphertext C is generated by:
C=E_{K}(f(·₁,α₂)∥m)
by using a symmetric cryptographic function E, the key data K and a publicized proper function f, it is checked whether the following is satisfied:
$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} = υ , f ( {α}_{1}^{′} , {α}_{2}^{′} ) = {[ {D}_{{K}^{′}} ( C ) ]}^{k}$$
where f outputs a value of k bits and [x]^{k} indicates the upper k bits of x, and if the check passes, a decipher process is executed by:
m=[D_{K′}(C)]^{-k}
where [x]^{-k} indicates a bit train with the upper k bits of x being removed.

8. A cryptographic communication method comprising:
a key generation step of generating a secret-key:
x₁, x₂, y₁₁, y₁₂, y₂₁, y₂₂ z∈ [symbol] _{q}
and a public-key:
p, q: prime number (q is a prime factor of p-1)
g₁,g₂ Å [symbol] ₚ: ordₚ(g₁)=ordₚ(g₂)=q
c=g₁^{x}^{₁}g₂^{x}^{₂} mod p, d₁=g₁^{y11}g₂^{y12} mod p, d₂=g₁^{y21}g₂^{y22} mod p, h=g₁^{z} mod p,
k₁, k₂, k₃: positive constant (10^{k}^{₁}^{+k}^{₂}<q, 10^{k}^{₃}^{<q,} 10^{k}^{₁}^{+k}^{₂}^{+k}^{₃}<p)
E: symmetric encipher function
a ciphertext generation and transmission step of selecting random numbers α=·₁∥α₂(|α₁=k₁, |α₁|=k₂) for key data K (|K|=k₃ where |x| is the number of digits of x), calculating:
\tilde{m}=α∥K
selecting a random number r∈Zq, calculating:
u₁=g₁^{r} mod p, u₂=g₂^{r} mod p, e=\tilde{m}h^{r}mod p, v=g₁¹^{₁}c^{r}d₁^{αr}d₂^{Kr} mod p
and generating a ciphertext C of transmission data by:
C=EK₍m)
by using a (symmetric) cryptographic function E and the key data K, and transmitting (u₁, u₂, e, V, C) as the ciphertext; and
a ciphertext reception and decipher step of calculating from the received ciphertext and by using the secret key, α′₁, α′₂, K′ (|α′₁|=k₁, |α₂|=k₂, |K′|=k₃) which satisfy:
α′₁∥α′₂₁∥K′=e/u₁^{z} mod p
and if the following is satisfied:
$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} ≡ υ ( mod p )$$
where α′=α′₁∥α₂, executing a decipher process by:
m=D_{K}′(C)
outputting deciphered results, whereas if not satisfied, outputting as the decipher results the effect that the received ciphertext is rejected.

9. A cryptographic communication method according to claim 8, wherein the ciphertext C is generated by:
C=E_{K}(f(α₁, α₂)∥m)
by using a symmetric cryptographic function E, the key data K and a publicized proper function f, it is checked whether the following is satisfied:
$${{g}_{1}}^{{α}_{1}^{′}} {{u}_{1}}^{{x}_{1} + {α}^{′} {y}_{11} + {K}^{′} {y}_{21}} {{u}_{2}}^{{x}_{2} + {α}^{′} {y}_{12} + {K}^{′} {y}_{22}} ≡ υ ( mod p ) , \\ f ( {α}_{1}^{′} , {α}_{2}^{′} ) = {[ {D}_{{K}^{′}} ( C ) ]}^{k}$$
where f outputs a value of k bits and [x]k indicates the upper k bits of x, and if the check passes, a decipher process is executed by:
m=[D_{K′}(C)]^{-k}
where [x]^{-k} indicates a bit train with the upper k bits of x being removed.

10. A cryptographic communication method according to claim 6, wherein the public-key is generated by a receiver and is made public.

11. A cryptographic communication method according to claim 6, wherein in said ciphertext transmission step, the random numbers α₁, α₂ ((α₁∈X₁, α₂∈X₂) and r∈Zq are selected beforehand and the following is calculated and stored beforehand:
u₁=g₁^{r}, u₂=g₂^{r}, h^{r}, g₁^{α1}c^{r}d₁αr

12. A cryptographic communication method according to claim 6, wherein in said ciphertext transmission step, the random numbers α₁, α₂ (|α₁|=k₁, |α₁|=k₂) and r∈Zq are selected beforehand and the following is calculated and stored beforehand:
u₁=g₁^{r}mod p, u₂=g₂^{r} mod p, h^{r} mod p, g₁^{α}^{₁}c^{r}d₁^{αr} mod p

13. A cryptographic communication method comprising:
a key generation step of generating a secret-key:
x₁, x₂, y₁, y₂,z∈ [symbol] _{q}
and a public-key:
G, C′: finite (multiplicative) group G⊂G′
q: prime number (the order of G)
g₁,g₂∈G
π: X₁×X₂×M→Dom(E): one-to-one mapping (Dom(E) is the domain of the function E)
π⁻¹: Im(π) X₁×X₂×M
H: hash function
E: symmetric encipher function
where the group G is a partial group of the group G′, X₁ and X₂ are an infinite set of positive integers which satisfy:
α₁∥α₂<q(∀α₁∈X₁, ∀α₂∈X₂)
a ciphertext generation and transmission step of selecting random numbers α₁=X₁, α₂X₂, r∈Zq, calculating:
u₁=g₁^{r},u₂=g₂^{r}, v=g₁^{α1}c^{r}d^{αr}, K=H(h^{r})
where α=α∥α₂, generating a ciphertext C of transmission data m by
C=E_{K}(π(α₁,α₂,m))
by using a (symmetric) cryptographic function E; and transmitting (u₁, u₂, V, C) as the ciphertext; and
a ciphertext reception and decipher step of calculating:
K′=H(u₁^{z})
by using the secret key, calculating from the received ciphertext, α′₁, α′₂ (where α′₁∈X₁, α′₂∈X₂) which satisfy:
π(α′₁, α′₂, m′)=D_{K′}(C)
if the following is satisfied:
$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} = υ ,$$
where (α′=α′₁λα′₂
outputting m′ as the deciphered results, whereas if not satisfied, outputting as the decipher results the effect that the received ciphertext is rejected.

14. A cryptographic communication method comprising:
a key generation step of generating a secret-key:
x₁,x₂, y₁, y₂, z∈ [symbol] _{q}
and a public-key:
p. q: prime number (q is a prime factor of p-1) _{b}₁,g₂∈ [symbol] ₚ: ordₚ(g₁)=ordₚ(g₂)=q
c=g₁^{z}^{₁}g₂^{x}^{₂} mod p, d=g₁^{y1}g₂^{y2} mod p, h=g₁^{z} mod p,
k₁, k₂, k₃: positive constant (10^{k}^{₁}^{+k}^{₂}<q, 10^{k}^{₃}<q, 10^{k}^{₁}^{+k}^{₂}^{+k}₃<p)
H: hash function
E: symmetric encipher function (the domain of E is all positive integers)
a ciphertext generation and transmission step of selecting random numbers α=α₁∥α₂(|α₁|=k₁, |α₂|=k₂, where (|x| is the number of digits of x), selecting a random number rEZq, calculating:
u₁=gₗ^{r} mod p, u₂=g₂^{r} mod p, v=g₁^{α1}c^{r}d^{αr} mod p, K=H(h^{r} mod p)
transmitting the ciphertext (u₁, u₂, V, C); generating a ciphertext C of transmission data m by:
c=E_{K}(α₁μα₂∥m)
by using a (symmetric) cryptographic function, and transmitting (u₁, u₂, v, C) as the ciphertext;
a ciphertext reception and decipher step of calculating:
K′=H(u₁^{z} mod p)
by using the secret key, calculating from the received ciphertext, α′₁, α′₂ (|α′₁|=k₁, |α′₂|=k₂) which satisfy:
α′₁∥α₂∥m′=D_{K′}(C)
and if the following is satisfied:
$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} ≡ υ ( mod p )$$
outputting m′ as the deciphered results (where α′=α′₁∥α″₂), whereas if not satisfied, outputting as the decipher results the effect that the received ciphertext is rejected.

15. A cryptographic communication method according to claim 13, wherein the public-key is generated by a receiver and is made public.

16. A cryptographic communication method according to claim 13, wherein in said ciphertext transmission step, the random numbers α₁, α₂ (α₁∈X₁, α₂∈X₂) and r∈Zq are selected beforehand and the u₁, u₂, e and v are calculated and stored beforehand.

17. A cryptographic communication method according to claim 14, wherein in said ciphertext transmission step, the random numbers α₁, α₂ (|α₁|=k₁, |α₂|=k₂), and r∈Zq are selected beforehand and the u₁, u₂, e and v are calculated and stored beforehand.

18. A cryptographic communication method comprising:
a key generation step of generating a secret-key:
x₁, X₂, y₁, y₂ ∈ [symbol] _{q}
sk: (asymmetric cryptography) decipher key
and a public-key:
G: finite (multiplicative) group
q: prime number (the order of G)
g₁, g₂∈G
c=g₁^{α}^{₁}g₂^{α}^{₂}, d=g₁^{y1}g₂^{y2},
π: X₁×X₂×M→Dom(E): one-to-one mapping (Dom(E) is the domain of the function E)
π⁻¹:Im(π)→X₁×X₂×M
Eₚₖ(·): (asymmetric cryptography) encipher function
where the group G is a partial group of the group G′, X₁ and X₂ are an infinite set of positive integers which satisfy:
α₁∥α₂<q(∀α₁∈X₁, ∀α₂∈X₂)
where M is a plaintext space;
a ciphertext generation and transmission step of selecting random numbers α₁∈X₁, α₂∈X₂, r∈Zq calculating:
u₁=g₁^{r}, u₂=g ₂^{r}, v=g₁^{α}^{₁}c^{r}d^{αr}
where α=α₁∥α₂, generating a ciphertext C of transmission data m by:
e=Eₚₖ(π(α₁α₂, m))
by using an (asymmetric) cryptographic function Eₚₖ, and transmitting (u₁, u₂, e, v) as the ciphertext; and
a ciphertext reception and decipher step of calculating from the received ciphertext and by using the secret key, α′₁, α′₂, m′ ((α′₁∈X₁, α′₂∈₂∈X₂, m′∈M)
which satisfy:
π(α′₁,α₂,m′)=Dₛₖ(e)
and if the following is satisfied:
$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} = υ$$
where:
α′=α′₁∥α₂
outputting m′ as the deciphered results, whereas if not satisfied, outputting as the decipher results the effect that the received ciphertext is rejected.

19. A cryptographic communication method comprising:
a key generation step of generating a secret-key:
x₁,x₂,y₁, y₂∈Zq
sk: (asymmetric cryptography) decipher key
and a public-key:
p,q: prime number (q is a prime factor of p-i)
g₁,g₂∈ [symbol] ₚ : ordₚ(g₁)=ordₚ(92)=q
c=g₁^{x}^{₁}g₂^{x}^{₂} mod p, d=g₁^{y11}g₂^{y2} mod p,
k₁, k₂ positive constant (10^{k}^{₁}^{+k}^{₂}<q)
Eₚₖ(·): (asymmetric cryptography) encipher function (the domain is all positive integers)
a ciphertext generation and transmission step of selecting random numbers α=α₁∥α₂(|α₁|=k₁, |α₂|=k₂, where |x| is the number of digits of x), selecting a random number rEZq, calculating:
u₁32 =g₁^{r} mod p, u₂=g₂^{r} mod p, v=g₁^{α1}c^{r}d^{αr} mod p
generating a ciphertext C of transmission data m (positive integer) by:
e=Eₚₖ(α₁∥α₂∥m)
by using the secret key, and transmitting (u₁, u₂, e, v) as the ciphertext; and
a ciphertext reception and decipher step of calculating from the received ciphertext and by using the secret key, α′₁, α′₂, m′ (|α′₁|=k₁, |α′₂₁|=k₂, m′ is a positive integer) which satisfy:
α′₁|α′₂∥Dₛₖ(e)
and if the following is satisfied:
$${{g}_{1}}^{{α}_{1}^{′}} {{u}_{1}}^{{x}_{1} + {α}^{′} {y}_{1}} {{u}_{2}}^{{x}_{2} + {α}^{′} {y}_{2}} ≡ υ ( mod p ) ,$$
where:
α′=α′₁∥α′₂
outputting m′ as the deciphered results, whereas if not satisfied, outputting as the decipher results the effect that the received ciphertext is rejected.

20. A cryptographic communication method according to claim 18, wherein the public-key is generated by a receiver and is made public.

21. A cryptographic communication method according to claim 18, wherein in said ciphertext transmission step, the random numbers α₁, α₂ ((α₁∈X₁, α₂∈X₂) and r∈Zq are selected beforehand and the u₁, u₂ and v are calculated and stored beforehand.

22. A cryptographic communication method according to claim 19, wherein in said ciphertext transmission step, the random numbers α₁, α₂ (|α₁=k₁, |α₂|=k₂), and r∈Zq are selected beforehand and the u₁, u₂ and v are calculated and stored beforehand.
